(19) United States
(12) Patent Application Publication
(10) Pub. No.: US 2008/0122981 A1
(43) Pub. Date: May 29, 2008

(54) Video signal processing circuit

(75) Inventor: Shunsuke Serizawa, Gunma (JP)

Correspondence Address: OLIFF & BERRIDGE, PLC, P.O. BOX 320850, ALEXANDRIA, VA, 22320-4850, US

(73) Assignees: SANYO ELECTRIC CO., LTD, MORIGUCHI-SHI (JP); SANYO SEMICONDUCTOR CO., LTD., ORA-GUN (JP)

(21) Appl. No.: 11/984,975

(22) Filed: Nov. 26, 2007

(30) Foreign Application Priority Data
Nov. 29, 2006 (JP) 2006-322056

(51) Int. Cl. H04N 9/66

(52) U.S. Cl. 348/649; 348/E09.046

(57) ABSTRACT

Normal operation is assured in a video signal processing circuit having an Y/C separator when a switch is made from a transmission mode in which the Y/C separator is bypassed to a separation mode in which Y/C separation is performed. When the controller (10) receives an instruction to switch from the transmission mode in which the driving of the Y/C separator (4) has been stopped to the separation mode in which the Y/C separator (4) is driven, the Y/C separator (4) is driven and the operation of the buffer memory in the Y/C separator (4) is started (S50). When the controller (10) counts the 1H cycle pulses and detects (S52) that the period of time that the video signal can be held in buffer memory has elapsed (S52), the controller evaluates (S54) the arrival of a timing devoid of a burst interval, for example, and switches the switching circuit (8) from a state in which the output of the bypass circuit is transmitted and sets the switching circuit in a state in which the luminance signal Y and the color signal C generated by the Y/C separator (4) are transmitted (S56).

### CROSS-REFERENCE TO RELATED APPLICATION

The priority application number JP2006-322056 upon which this patent application is based is hereby incorporated by the reference.

### BACKGROUND OF THE INVENTION

1. Field of the Invention

The present invention relates to a video signal processing circuit in which Y/C separation is carried out when the input video signal is a composite signal, and in which the input video signal is transmitted unchanged when Y/C separation is not required.

2. Description of the Related Art

An Y/C separator is a circuit for separating the luminance signal Y and the color signal C from a composite video signal. Therefore, Y/C separation is not required when the input video signal is a component signal or a black-and-white signal, for example. In view of this situation, there are video signal processing circuits such as the circuit disclosed in Japanese Laid-open Patent Publication No. 5-183931 in which Y/C separation is carried out when the input video signal is a composite video signal, and in which the input video signal is transmitted (passed through) and outputted in other cases.

Such a video signal processing circuit has a bypass pathway in parallel with the Y/C separator, and the output of the Y/C separator or the output of the bypass pathway is selectively brought out by a switching circuit. In such a circuit, the driving of the Y/C separator can be stopped and lower power consumption can be ensured in the transmission mode in which the output of the bypass channel has been selected by the switching circuit. On the other hand, the switching circuit is switched and the supply of power to the Y/C separator is started up when a switch is made from the transmission mode to a separation mode in which the composite video signal undergoes separation.

However, stopping the Y/C separator presents a problem in that a stable Y/C separation process cannot be performed until the Y/C separator has started up when a return is made from the transmission mode to the separation mode in which Y/C separation is carried out. In particular, a comb-shaped filter (comb filter) that constitutes the Y/C separator holds the leading video signal for a prescribed period of time in the line memory or the frame memory on the basis of, e.g., a FIFO (First-In First-Out) operation, and reduces noise and separates the luminance signal and the color signal by using the correlation between the lines or the frames. For this reason, the stored content of the memory is lost when the power supplied to the Y/C separator is stopped, and the stored content of the memory is indefinite at the time the return is made.

Also, a time interval is generated between the video signal stored in memory prior to stoppage and the video signal after the return even when the memory is a nonvolatile memory, and Y/C separation cannot be performed using the correlation between the two video signals.

There is therefore a problem in that a normal state of the output of the Y/C separator cannot be guaranteed after the return until the content of the memory is updated with a new video signal. This is a problem because it is possible that, for example, normal operation in a latter-stage signal processing circuit cannot be assured.

### SUMMARY OF THE INVENTION

The present invention provides a video signal processing circuit in which a normal processing signal produced by the Y/C separator is outputted to a latter-stage signal processing circuit when a switch is made from a transmission mode to a separation mode.

The video signal processing circuit of the present invention comprises an Y/C separator for separating and generating a luminance signal and a color signal from a composite signal when an input video signal is the composite signal; a bypass circuit that is provided in parallel with the Y/C separator and that transmits the input video signal; a switching circuit to which a generated signal from the Y/C separator and a transmitted signal from the bypass circuit are inputted, and which switches between a separation mode that outputs the generated signal and a transmission mode that outputs the transmitted signal; and a controller for controlling switching of the switching circuit and the driving of the Y/C separator in accordance with a control signal that comes from an external unit and instructs a switch to be made between the separation mode and the transmission mode, wherein the controller operates in coordination with an instruction to switch to the transmission mode, sets the switching circuit to the transmission mode, and stops the driving of the Y/C separator; and, conversely, starts the driving of the Y/C separator and sets the switching circuit to the separation mode after a prescribed delay period has elapsed since the start of driving in response to an instruction to switch to the separation mode.

### BRIEF DESCRIPTION OF THE DRAWINGS

FIG. 1 is a schematic block diagram of a video signal processing circuit as an embodiment of the present invention;

FIG. 2 is a block diagram showing an example of a basic configuration of an Y/C separator; and

FIG. 3 is a generalized flowchart showing the operation of switching from the transmission mode to the separation mode.

### DESCRIPTION OF THE PREFERRED EMBODIMENTS

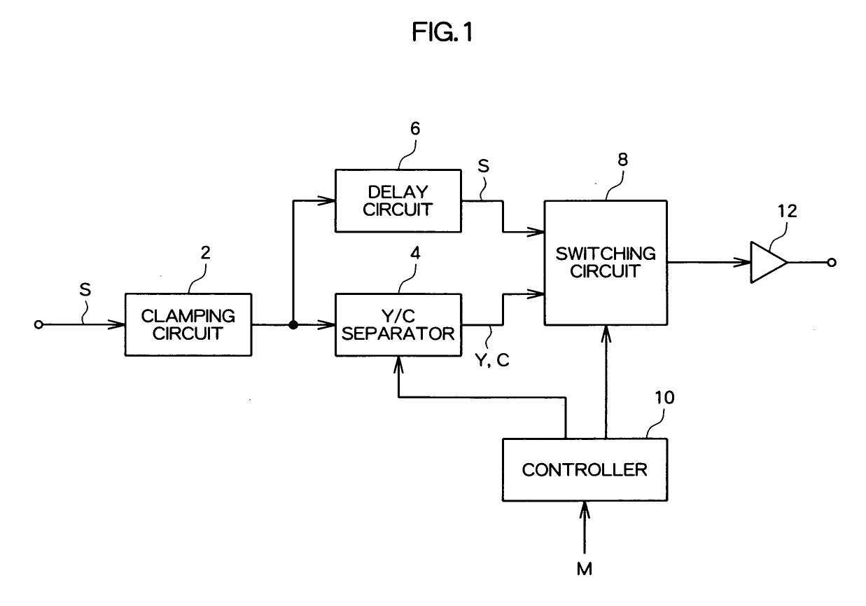

Modes of implementing the present invention (hereinafter referred to as “embodiments”) are described below with reference to the diagrams. FIG. 1 is a schematic block diagram of a video signal processing circuit as an embodiment. The present circuit is composed of a clamping circuit 2, an Y/C separator 4, a delay circuit 6, a switching circuit 8, a controller 10, and an output buffer circuit 12.

The present circuit can perform Y/C separation on a composite video signal and can generate a luminance signal Y and a color signal C. The present circuit can switch between a separation mode for separating an Y/C signal, and a transmission mode for transmitting a signal unchanged, in accordance with a control signal from an external unit.

The clamping circuit 2 is presented with a digitalized video signal S from an input terminal of the present circuit and performs digital clamping. The video signal is initially clamped as an analog signal, and digital clamping is performed again in the clamping circuit 2 in order to remove changes that occur over time due to temperature and other factors. The black level can thereby be faithfully reproduced. The output of the clamping circuit 2 is inputted to the Y/C separator 4 and the delay circuit 6.

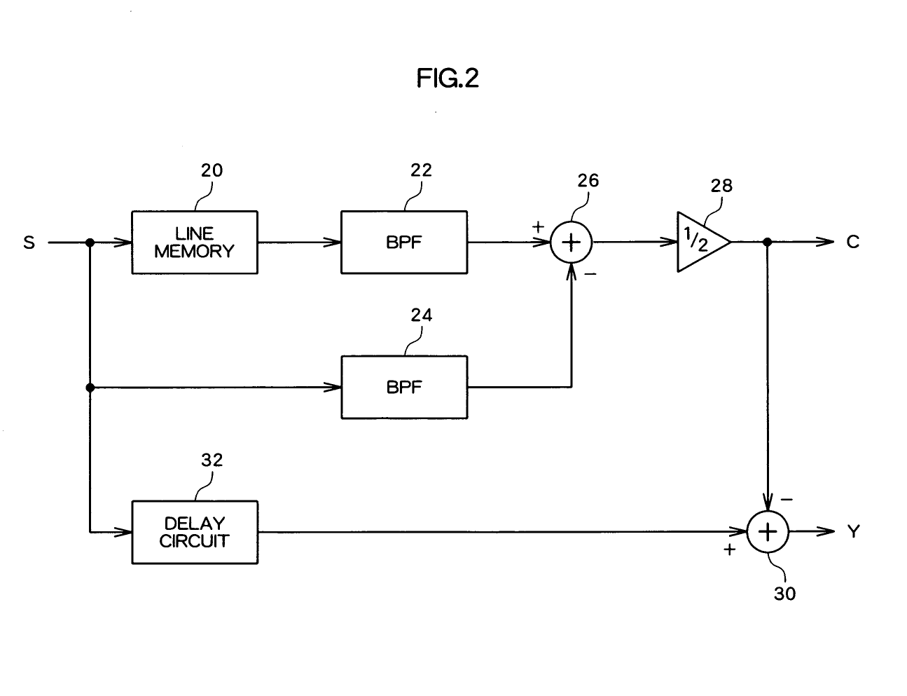

The Y/C separator 4 generates a luminance signal Y and a color signal C from the composite video signal by a line correlation method or a frame correlation method, and outputs the result to the switching circuit 8. FIG. 2 is a block diagram showing an example of a basic configuration of the Y/C separator 4.

The video signal inputted to the Y/C separator 4 is inputted to an adder 26 via a pathway composed of a line memory 20 and a band-pass filter (BPF) 22, and a pathway composed of a BPF 24. The line memory 20 retains the video signal of a single horizontal scan interval (1H) by a FIFO operation. The BPFs 22 and 24 extract a color signal band centered on a video sub-carrier (3.58 MHz) of a composite video signal. The adder 26 receives the current video signal as input from the BPF 24, receives the video signal of 1H prior as input from the BPF 22, and generates a difference signal thereof. In other words, the video signals of adjacent two lines are inputted to the adder 26. In this case, since the color signal C is phase-inverted every line, it is possible, in principle, to cancel out the luminance signal Y mixed with the output of the BPFs 22 and 24 and to extract the color signal C when the difference in video signals between the two lines is obtained in the case that the two adjacent lines, i.e., the luminance and color are exactly the same. The color signal C can be advantageously extracted using this process because two adjacent lines are correlated in many cases. Since the value of the color signal C outputted from the adder 26 is doubled, the value is halved by a divider 28 and outputted from the Y/C separator.

On the other hand, the luminance signal is the component that remains after the color signal C has been removed from the composite video signal. In view of this fact, the video signal inputted to the Y/C separator 4 and the color signal C outputted from the divider 28 are inputted to an adder 30, the difference is calculated, and the luminance signal Y is generated. A delay circuit 32 provided to the input pathway of the video signal produces a delay that corresponds to the processing time in the circuit that generates the color signal C, and adjusts the timing between the two input signals to the adder 30.

Here, a configuration based on a two-line correlation is described as the simplest configuration of the Y/C separator 4, but a configuration with a comb filter that uses two or more line memories, and a configuration in which frame memory is used to perform 3D-Y/C separation using a correlation in the time axis direction can also be employed in order, for example, to reduce cross coloring that can occur when the image changes considerably between two lines, or to achieve other effects. The line memory, frame memory, or another buffer memory used in the present circuit is composed of, e.g., DRAM or another nonvolatile memory.

The Y/C separator 4 can cut power and stop driving during the transmission mode. Power consumption in the transmission mode can thereby be reduced.

A video signal is inputted from the input terminal of the present circuit to the switching circuit 8 in the transmission mode via a bypass circuit connected in parallel with the Y/C separator 4. The bypass circuit in FIG. 1 is the signal pathway provided with the delay circuit 6. In the delay circuit 6, a delay time that corresponds to the signal processing time in the Y/C separator 4 is set, and a match is established for the timing of the output of the Y/C separator 4 inputted to the switching circuit 8 and the output of the bypass circuit. The situation in which the timing of the video signals becomes offset is prevented during mutual switching between the separation mode and the transmission mode.

The bypass circuit from the clamping circuit 2 to the switching circuit 8 may be configured without having the delay circuit 6. For example, the bypass circuit may be implemented by a simple wire that connects the clamping circuit 2 and the switching circuit 8.

The switching circuit 8 is presented with the luminance signal Y and the color signal C from the Y/C separator 4, or with the video signal S from the delay circuit 6, and outputs one of the two to the output buffer circuit 12. The switching control of the switching circuit 8 is carried out in accordance with a control signal from the controller 10.

The controller 10 controls the operation of each unit of the present circuit. For example, the controller 10 is presented with a control signal M from an external unit of the present circuit and switches the circuit between operation in the separation mode and operation in the transmission mode. When the control signal M is an instruction to switch from the separation mode to the transmission mode, the controller 10 sets the switching circuit 8 so that the video signal from the delay circuit 6 passes through and stops the driving of the Y/C separator 4 in order to reduce power consumption.

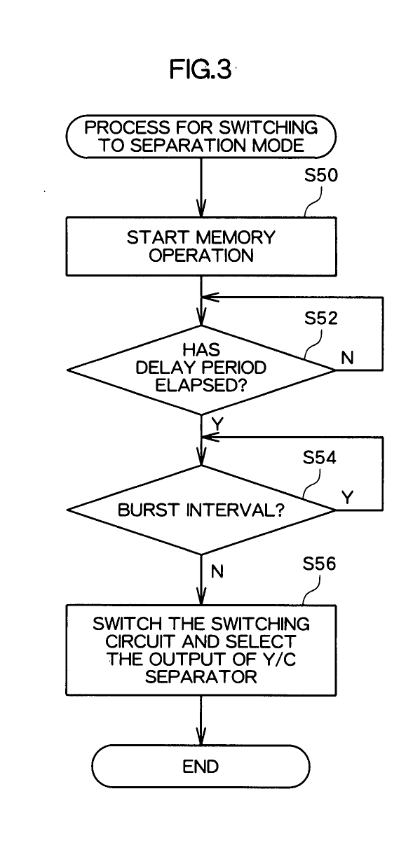

On the other hand, when the control signal M is an instruction to switch from the transmission mode to the separation mode, the driving of the Y/C separator 4 is restarted before the switching circuit 8 is switched. FIG. 3 is a generalized flowchart showing the operation of switching from the transmission mode to the separation mode. In this case, the controller 10 restarts the driving of the Y/C separator 4 in accordance with the control signal M. The buffer memory inside the Y/C separator 4 begins operation and the video signal inputted to the Y/C separator 4 is stored in the buffer memory in accordance with the lapse of time (S50). The stored content of the buffer memory is completely overwritten with a new video signal upon the lapse of the delay time that corresponds to the period of time during which the video signal can be held in memory since the start of buffer memory operation (S52). For example, the controller 10 is presented with the pulses composed of 1H cycles generated in coordination with the horizontal synchronization signals or a color burst signals that appear in the horizontal blanking period of the video signal. These pulses are counted and the lapse of the delay period is detected. After the delay period has elapsed, the Y/C separator 4 can correctly perform Y/C separation on the basis of the updated content of the buffer memory.

For example, the controller 10 evaluates the arrival of a timing devoid of a burst interval after the delay period has elapsed (S54), switches the switching circuit 8, and establishes a setting so that the luminance signal Y and the color signal C generated by the Y/C separator 4 are transmitted (S56). For example, the effect on the synchronization operation of using the burst signal can be avoided and synchronization can be rapidly achieved by avoiding a switch midway through a color burst interval. On the other hand, there is essentially no problem if the configuration in one in which the switching operation of the switching circuit 8 is carried out with any timing regardless of whether the timing is in a color burst interval.

A video signal processing circuit that processes a digital signal is described as an embodiment above, but the video signal processing circuit of the present invention may also similarly process an analog signal.

As described in the embodiment described above, the video signal processing circuit of the present invention has an Y/C separator for separating and generating a luminance signal and a color signal from a composite signal when an input video signal is the composite signal, and a bypass circuit that is provided in parallel with the Y/C separator and that transmits the input video signal. A generated signal (i.e., the luminance signal and color signal) from the Y/C separator and a transmitted signal from the bypass circuit are inputted to a switching circuit. The switching circuit is a selector circuit that selectively outputs a generated signal or a transmitted signal, and outputs the generated signal in a separation mode, and a transmitted signal in a transmission mode. A controller controls the switching of the switching circuit and the driving of the Y/C separator in accordance with a control signal that comes from an external unit and instructs a switch to be made between the separation mode and the transmission mode. The controller operates in coordination with an instruction to switch to the transmission mode, sets the switching circuit to the transmission mode, and stops the driving of the Y/C separator. On the other hand, the controller starts the driving of the Y/C separator and sets the switching circuit to the separation mode after a prescribed delay period has elapsed since the start of driving in response to an instruction to switch to the separation mode.

A preferred aspect of the present invention is a video signal processing circuit in which the Y/C separator has a buffer memory for storing a input video signal on the basis of a FIFO operation, and further has a separator unit for subjecting the composite signal to a separation process by using the input video signal that occurs within a prescribed leading period of time and is stored in the buffer memory, wherein the delay period is set in accordance with the leading period of time. In the embodiment described above, the Y/C separator 4 is provided with a line memory 20 as a buffer memory, and has a separation unit that is composed of BPFs 22 and 24, adders 26 and 30, a divider 28, and a delay circuit 32.

In the embodiment above, a configuration is described in which the leading period of time is 1H as an example in which the leading period of time is an integral multiple of the horizontal scan interval. The controller 10 causes the delay period to last from the start of driving until the generation timing of the first color burst signal after the leading interval has elapsed, and sets the switching circuit 8 to the separation mode in the interval that starts after the period of generation of the color burst signal included in a horizontal blanking interval and ends when the horizontal blanking interval is completed.

In accordance with the present invention, the driving of the Y/C separator is started in accordance with an instruction to switch to the separation mode. The generated signal of the Y/C separator is subsequently not outputted from the switching circuit until a prescribed delay period of time has elapsed. The transmitted signal of the bypass circuit is outputted from the switching circuit during this interval. The video signal processing signal of the present invention can thereby suppress the output of generated signals for which normal characteristics cannot be guaranteed during the time that the Y/C separator is starting up, and can output a generated signal to a latter-stage video signal processing circuit after the signal state has normalized. Therefore, it is possible to assure normal operation of a latter-stage video signal processing circuit, and, for example, to prevent image degradation during mode switching.

What is claimed is:

1. A video signal processing circuit, comprising:
an Y/C separator for separating and generating a luminance signal and a color signal from a composite signal when an input video signal is the composite signal;
a bypass circuit that is provided in parallel with the Y/C separator and that transmits the input video signal;
a switching circuit to which a generated signal from the Y/C separator and a transmitted signal from the bypass circuit are inputted, and which switches between a separation mode that outputs the generated signal and a transmission mode that outputs the transmitted signal; and
a controller for controlling switching of the switching circuit and the driving of the Y/C separator in accordance with a control signal that comes from an external unit and instructs a switch to be made between the separation mode and the transmission mode, wherein
the control circuit operates in coordination with an instruction to switch to the transmission mode, sets the switching circuit to the transmission mode, and stops the driving of the Y/C separator; and, conversely, starts the driving of the Y/C separator and sets the switching circuit to the separation mode after a prescribed delay period has elapsed since the start of driving in response to an instruction to switch to the separation mode.

2. The video signal processing circuit of claim 1, wherein
the Y/C separator has a buffer memory for storing the input video signal on the basis of a FIFO operation, and further has a separator unit for subjecting the composite signal to a separation process by using the input video signal that occurs within a prescribed leading period of time and is stored in the buffer memory; and
the delay period is set in accordance with the leading period of time.

3. The video signal processing circuit of claim 2, wherein
the leading period of time is an integral multiple of the horizontal scan interval, and
the controller causes the delay period to last from the start of driving until the generation timing of the first color burst signal after the leading interval has elapsed, and sets the switching circuit to the separation mode in an interval that starts after the period of generation of the color burst signal included in a horizontal blanking interval and ends when the horizontal blanking interval is completed.
